(19) United States
(12) Patent Application Publication
(10) Pub. No.: US 2014/0363133 A1
(43) Pub. Date: Dec. 11, 2014

(54) METHOD TO ALIGN OPTICAL FIBER FOR SPLICING

(71) Applicant: Prima Electro North America. LLC, Chicopee, MA (US)

(72) Inventors: Pieter Schwarzenbach, Longmeadow, MA (US); Matthew J. Silva Sa, Worcester, MA (US); Peter Reeves-Hall, Northbridge, MA (US)

(21) Appl. No.: 13/911,254

(22) Filed: Jun. 6, 2013

(51) Int. Cl. G02B 6/255

(52) U.S. Cl. CPC G02B 6/2555
USPC 385/96; 385/97

(57) ABSTRACT

A method for aligning non-circular clad fiber whereby the alignment of the cross sectional profiles of non-circular fiber is accurately aligned before splicing. A method is provided to determine the correct rotational orientation of a fiber with non-circular cladding geometry so that the on screen position of the fiber core may be adjusted to present the flat side of the fiber cladding perpendicular to the imaging axis of the sensor. Once the fiber is clamped into the splicing apparatus multiple images at a series of different known rotational angles are captured. The images are processed to locate key fiber structural features. The relationship between the relevant structures is then processed mathematically to calculate a rotational angle that corresponds to a symmetrical positioning of the core as within the cladding image. The fiber is then rotated to the calculated rotational angle and the splice is completed.

### BACKGROUND OF THE INVENTION

The present invention relates generally to a method and system for aligning non-circular clad fibers. More specifically, the present invention relates to a method and system whereby the alignment of the cross sectional profiles of non-circular fiber assemblies are accurately aligned before the splicing thereof.

Advances in laser technology have allowed for the development of increasingly high powered systems. Such high powered systems include free space lasers, as well as lasers confined to waveguides, such as fiber lasers. Fiber lasers have significant advantages over traditional lasers, including stability of alignment, scalability and high optical power of a nearly diffraction limited output beam.

In a fiber laser, the gain medium is a length of an optical fiber, the core of which is doped with an active lasing material, typically ions of a rare earth element, such as erbium or ytterbium or both. The lasing material is usually pumped using an emission of a diode laser or an array of diode lasers. The advent of double clad active optical fibers, having inner claddings and outer coatings in which the pump light is coupled to the inner cladding to be absorbed at the doped fiber core along the fiber length, allowed a considerable increase in overall output power of a fiber laser, while preserving the brightness and directivity of a single mode output laser beam. Power levels of the order of several kilowatts or even tens of kilowatts in an almost single mode output laser beam are now achievable, opening a great variety of industrial applications, such as concrete drilling or sheet metal cutting for the car industry or shipbuilding.

A typical optical fiber as shown at FIG. 1 has a cross sectional profile that has three regions. A central core, a first cladding and a second cladding or coating of polymer or low index glass. Specialty fibers, shown by example at FIG. 2, such as doped or active optical fibers, however, typically have non circular cladding-coating boundaries to assist in bouncing laser pumping light being carried in the cladding towards the doped core to increase the pumping efficiency of the active fiber. Such non-circular cladding shapes may include square, hexagonal, elliptical, octagonal etc.

In a traditional splicer, the alignment is typically made using side view cameras at 90 degrees orientation to each other to ensure alignment of the fiber core in the X and Y axis. Alignment through imaging can be made in three main ways: 1) aligning using the imaged core being the most accurate method, 2) aligning using the imaged outer cladding edge, this being the least accurate as the optical fiber has some off axial alignment error of the core within the cladding, and 3) a combination of both of the above methods, still typically not as accurate as the core alignment method. Alternative alignment methods include imaging of the fiber end faces wherein the imaging unit is then withdrawn and the fiber ends are brought together. This adds to the cost and complexity of the splice machine and requires additional optics. Further methods are available using active alignment where the fiber core of one fiber is illuminated and detected on the opposing fiber using a meter or photon detector. This however also increases the cost and complexity of splicing.

The core alignment process being the most accurate is of particular interest, Core alignment is based upon analysis of core images extracted from light intensity profiles of the fibers to be spliced. In such processes, a core image of a considered fiber is obtained by illuminating the fiber from the side thereof using an external light source. It has been demonstrated theoretically as well as experimentally that the core image of a fiber can be resolved by placing the object plane of a high resolution imaging system near the fiber edge, as seen from the imaging system, where the light rays leave the fiber. Using information extracted from the core image, various automatic core alignment processes have been developed.

Using these processes, in the pictures taken of fibers to be spliced, the vertical distance between the positions of the e.g. upper edge of the cladding and of the approximate center of the core image is measured for each fiber, the fibers as conventional assumed to be located horizontally in the pictures. The alignment is performed by then displacing the two fibers in relation to each other so that the difference of said two measured distances of the two fibers becomes equal to the vertical difference between the positions of the upper edges of the claddings of the two fibers. Since this method relies on the information extracted from both the core images and images of the edges of the cladding, it is difficult to perform an accurate core alignment. Due to the significant differences in regard of refractive indices, light passing only through the claddings behaves differently compared to the light passing through both the cladding and the core. Thus, the optimum position of the object plane to get core images of a high quality is not equal to the optimum position to get images of the cladding edges that have a high quality. This fact implies that it may not be possible to simultaneously measure the positions of the core and the cladding edges of a fiber with a high accuracy, this in turn resulting in a degradation of the alignment accuracy when based on such pictures. The need for information about the position of the cladding edges in the alignment process also results in a need for special imaging systems including huge sensors that are very expensive and hence may not be cost effective in the manufacture of splicers.

One of the major problems with non-circular clad fibers is the fact that it is very difficult to achieve high quality splices of such fibers using traditional splicing techniques. As shown at FIG. 3, the major difficulty in making such a splice is the failure of the traditional core alignment processes that are used in conventional fusion splicers. In such apparatuses the non-circular clad fibers shown in the examples above will bend the light rays used for imaging the core in a direction that is dependent on the rotational position of the fiber around its longitudinal axis and its cladding. When viewed on screen the core image appears to be off-center due to the difference in refractive index of the cladding glass and the gas/liquid/vacuum that the fiber is observed in preventing accurate alignment for both the core and cladding rotation of the two fibers.

There is therefore a need for a method to determine the correct rotational orientation of a fiber with non-circular cladding geometry so that the on screen position of the fiber core may be adjusted to present the flat side of fiber as a plane perpendicular to the axis of the imaging sensor of the camera so that core alignment before and/or after of a splice may be adjusted/determined to high accuracy.

### BRIEF SUMMARY OF THE INVENTION

In this regard, the present invention provides a method and system for aligning non-circular clad fibers whereby the alignment of the cross sectional profiles of non-circular fiber assemblies are accurately aligned before the splicing thereof. Preferably, the present invention provides a method to determine the correct rotation orientation of a fiber with non-circular cladding geometry so that the on screen position of the fiber core may be adjusted to present the flat side of the fiber cladding as a plane perpendicular to the imaging axis of the sensor of the camera so that core alignment before and/or after of a splice may be adjusted/determined to high accuracy.

Once the fiber is clamped into the splicing apparatus the fiber is imaged. The imaging step comprises the capturing of multiple images at a series of different known rotational angles. The images are processed to locate key fiber structural features and a key feature table is generated. The relationship between the relevant structures is then processed mathematically to calculate a rotational angle that corresponds to a symmetrical positioning of the core as within the cladding image. The fiber is then rotated to the calculated rotational angle and the process of final core alignment and splicing is completed.

It is an object of the present invention to provide rotational alignment of non-circular fibers using side view imaging and mathematical processing of the imaged locations of key visual features to center the core imaging of the fiber onscreen.

It is a further object of the present invention to use a core centered view to align the fiber for splicing with respect to another fiber core for greater splice accuracy and lower splice loss.

It is still a further object of the present invention to use a core centered view for analysis and estimation of splice losses or core misalignment after a fiber splice has been made.

It is still a further object of the present invention to provide a device with rotational alignment of non-circular fibers using side view imaging and mathematical processing of locations of visual features to center the core imaging for core alignment during fusion splicing.

These together with other objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a cross-sectional representation of an optical fiber;

FIG. 2 is a cross-sectional representation of an optical fiber having non-circular geometry;

FIG. 3 is a side image of an optical fiber having non-circular geometry at two different rotational positions;

FIG. 4 is a data plot depicting the image intensity of the various key features within an image of FIG. 3; and

FIG. 5 is a comparative plotting of the relative relationships between the key features of FIG. 4 taken at various rotational positions.

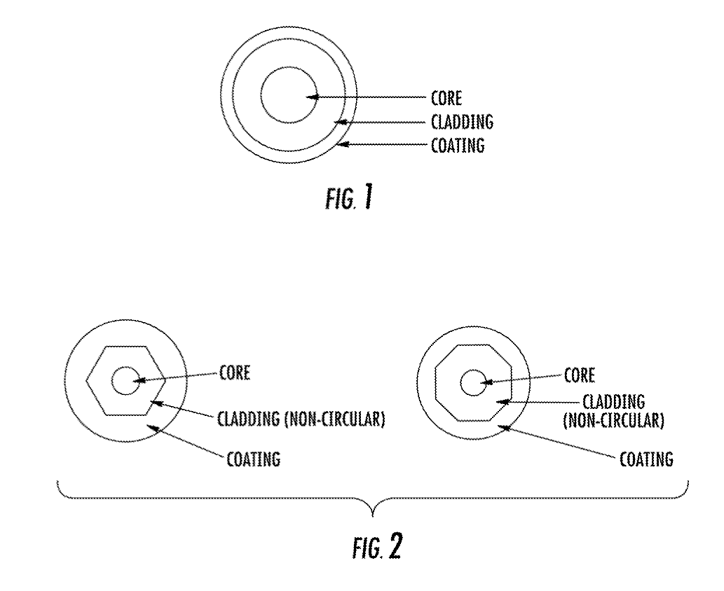

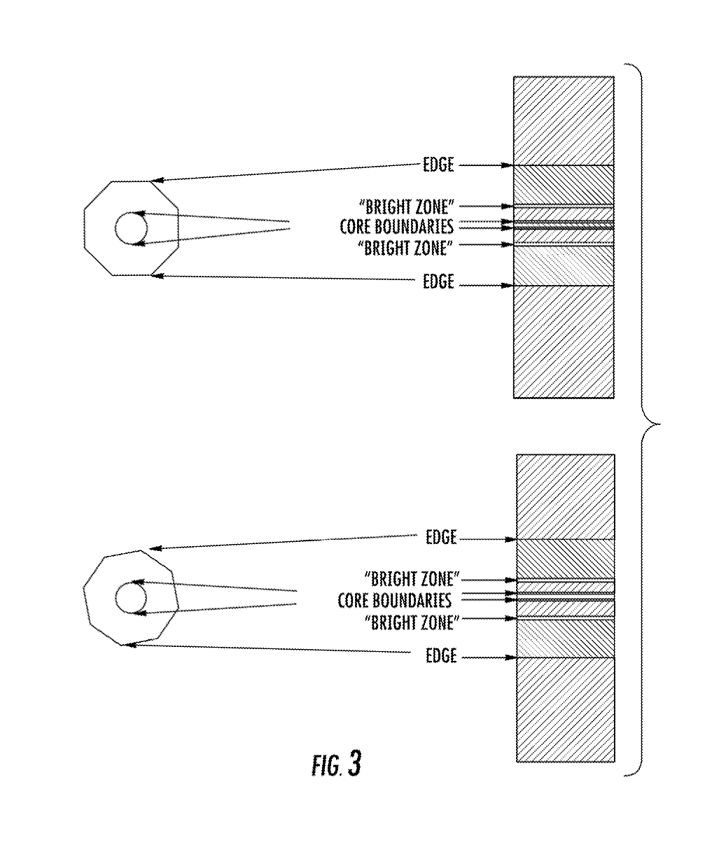

### DETAILED DESCRIPTION OF THE INVENTION

Now referring to the drawings, a system and method is provided for aligning the cores of the non-circular clad fibers whereby the alignment of the cross sectional profiles of non-circular fiber assemblies are accurately aligned before the splicing thereof. The present invention provides a method to determine the correct rotation orientation of a fiber with non-circular cladding geometry so that the on screen position of the fiber core may be adjusted to present the flat side of the fiber cladding as a plane perpendicular to the imaging axis of the sensor of the camera so that core alignment before and/or after of a splice may be adjusted/determined to high accuracy.

Most generally the fiber is clamped into the splicing apparatus where the fiber is imaged. The imaging step comprises the capturing of multiple images at a series of different known rotational angles. The images are processed to locate key fiber structural features and a key feature table is generated. The relationship between the relevant structures is then processed mathematically to calculate a rotational angle that corresponds to a symmetrical positioning of the core as within the cladding image. The fiber is then rotated to the calculated rotational angle and the splice is completed.

As stated above with respect to FIG. 3, when the fiber is imaged in good focus there are several key features that are observed. The core boundaries of the fiber are imaged as bright and dark bands due to refracted/reflected light that passes through the central portion of the core glass or is refracted/reflected at the edges off the core glass. The outer edges of the fiber cladding can be seen as the boundary between the background illumination and the outer edge of the cladding glass. These features appear as a bright line next to a dark inner zone due to refraction and reflection of the light passing therethrough in a direction towards (bright line) and away (dark zone) from the imaging camera. Finally, the bright zone regions appear as bright lines because greater than average amounts of light are being directed to the imaging camera due to refraction and reflection. As can be seen in the upper image of FIG. 3, if the fiber is well aligned (i.e. the plane of the nearest flat cladding edge is perfectly aligned perpendicular to the axis of the viewing optics/camera) then the core boundaries are observed as being centered with respect to both the edges and the bright zones. However, in other rotational alignments, the core appears off center due to the refraction of the imaging light rays based on the cladding surface being other than perpendicular to the imaging device.

Due to this off centered imaging that results from refraction caused by the facets or less than perpendicular relationship between the outer surface of the cladding and the imaging device, it is nearly impossible to reliably align the fiber core without first knowing the rotational relationship of the fiber and cladding outer surfaces. In this regard, the present invention discourses a method to reliably and automatically determine the correct rotational orientation of a fiber with non-circular cladding geometry. By determining the proper rotational alignment of the fiber, the fiber core may be adjusted to present the flat side of fiber as a plane perpendicular to the imaging axis of the sensor of the camera so that core alignment before and/or after of a splice may be adjusted/determined to high accuracy.

In the context of the present invention it should be understood that the disclosure is applicable to any non-circular fiber geometry including but not limited to fiber cross sections that are of any polygonal shape including square, hexagonal and octagonal as well as elliptical shapes.

The method of the present invention if used in a splicing procedure requires that the fiber splice machine include a means for controlled rotational adjustment of fibers clamped in holders and imaging sensor. Once the fibers are clamped into the splice machine the imaging sensors take an image of the fiber at a first rotational position. Further, while this step provides for taking a single image, multiple image frames may be captured and mathematically processed (e.g. averaging, statistical analysis, over sampling, image sharpening, etc.) to improve accuracy.

Using the image an intensity data set is generated based on the cross-sectional image of the fiber at that particular rotational position.

Next the key features of the fiber as described above are located within the image either manually or automatically relative to the cross-section of the fiber. As shown at FIG. 4, the image location (Y) and/or pixel intensity values of any/all key “features” in the image are charted to build a key features table/data-set using absolute locations and/or peak/valley/step/threshold or other detection algorithms. Preferably the key features located relative to the y-axis across the cross section of the of the fiber include the central core boundaries intensity peaks and/or dips (A, B), the bright zone intensity peaks (A, B), the edge intensity peaks and/or dips (A,B), background intensity level(s) and the dark zones.

The imaging process and analysis is then repeated for several different fiber rotation angles to generate a key feature data set for each rotational position. Preferably the process is repeated at 10 or more rotational positions over an aggregate of more than 10 degrees of rotation range.

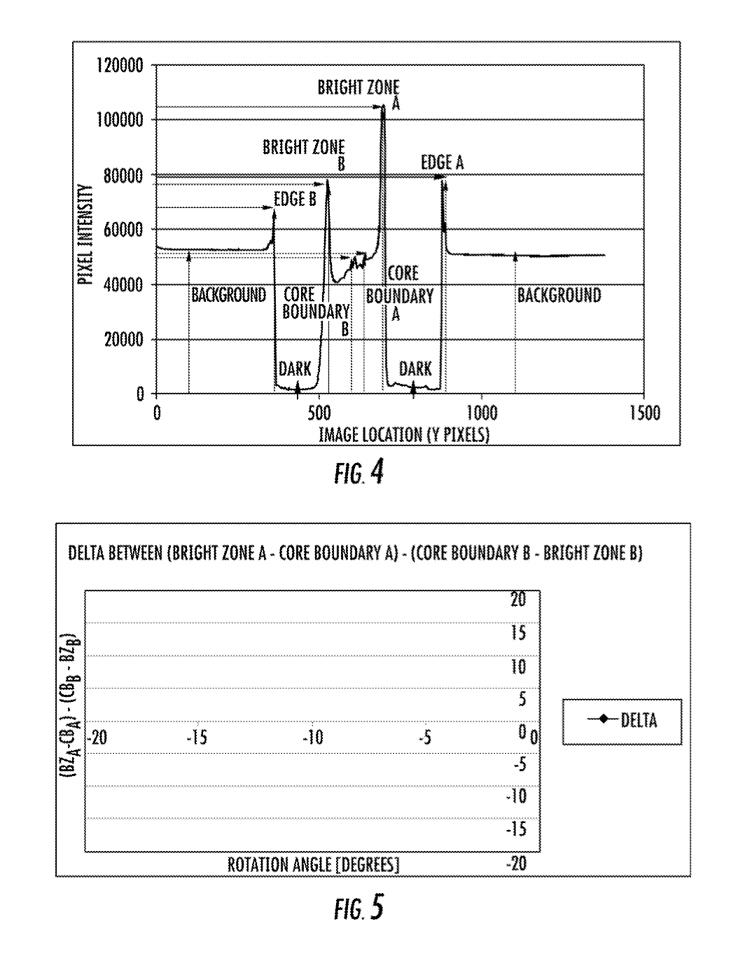

Given each of the key feature data sets for each of the rotational angles of the fiber, the data is mathematically processed to provide a relative separation in the y-axis between identified key features for each of the rotational angles imaged. This data is used to generate a relationship table such as is shown at FIG. 5. As shown a calculation is performed to determine the relative difference or delta as between the distance between the core boundary and the bright zone on both the A and B sides of the fiber at each of the rotational angles imaged. More specifically, a relative delta in terms of image pixels as between the core relative to the A and B bright zones is plotted for each of the rotational angles of the fiber. In this embodiment the calculation is as follows:

Delta=(Bright Zone A−Core Boundary A)−(Core Boundary B−Bright Zone B)

The step in the process therefore provides for the application of mathematical analysis (statistics, linear or curve fitting interpolation, nearest neighbor) to the “relationship” tables/data sets to calculate the rotation angle that corresponds to a flat side of the fiber being perpendicular to the imaging axis of the sensor. As can be seen at a rotational angle of −16 degrees the core image is shifted greatly toward the B bright zone while at a rotational angle of −8 degrees the core image is shifted greatly toward the A bright zone. What is also shown and of particular interest in the present invention is that at a rotational angle of approximately −12 degrees the core images is centered between the A and B bright zones.

Finally, the fiber is rotated to the optimum angle, −12 degrees in this case, that corresponds to the flat fiber edge being perpendicular to the optical axis of the imaging camera and proceeds to use the core and/or cladding positions as a reference for fiber alignment for splicing.

It should be appreciated to one skilled in the art that in the above illustrative embodiment key features used for relative referencing were the A and B core boundaries and the A and B bright zones, however, other structural relationships could also be used within the scope and intent of the present disclosure. Other possible examples of mathematical processing of “feature” data to make “relationship” data include, but are not limited to:
Distance (Y) between edge boundaries.
Distance between bright zones
Distance between core boundaries
Distance between neighboring edge boundaries and respective bright zones
Distance between neighboring edge boundaries and respective core boundaries
Distance between neighboring bright zones and respective core boundaries.
Pixel intensity difference between edge boundaries
Pixel intensity difference between bright zones
Pixel intensity difference between core boundaries.

It should also be understood that the calculation may further provide for a weighting of the data sets for increased accuracy based upon actual mechanical tolerances of the non-circular fiber being analyzed. For example the “relationship” data-sets may be generated by subtraction/addition/multiplication or other mathematical treatments of the relative Y-axis coordinate locations of structures with respect to each other and/or the pixel intensities of structures with respect to each other.

By way of example a step by step routine is provided for aligning an octagonal fiber for splicing to a circular fiber.
1) Placing fiber into fiber splicing assembly.
2) Imaging of Fiber—Image the non-circular cladding fiber (octagonal) multiple times at different know rotation angles.
3) Processing of image data
   a. For all the images determine the positions of various key structures on the perpendicular intensity data e.g. The Y position of the Edges A and B, the Y position of the bright zones A and B, the Y position of the core boundaries A and B to generate the key features table.
   b. Mathematically subtract coordinate locations of key features from other key features to generate the relationship table.
   c. Apply mathematical analysis (statistics, linear or curve fitting) to the relationship table data set to calculate the rotation angle that corresponds to symmetry of an edge on view or equally image intensities
      i. Plot rotation angle relative to the relative positional relationships
      ii. Linear fit the data
      iii. Solve the fit equation to determine the rotational angle that corresponds to relative positional relationships being equal to 0.
4) Rotate the fiber to the calculated optimum angle.
5) Align the cores of the two fibers to be spliced.
6) Splice
7) (optional) Since the rotation angle for core viewing should still be good after the splice—use the post splice image to determine core alignment and related losses pass/fail/rejection.

One skilled in the art should appreciate that other variables may be introduced within the scope of the invention as well. The analysis of the relative positional data may be made at any appropriate time within the process. For example the analysis may be made after every frame, after every group of frames and/or after capture of all frames. Similarly, the imaging camera may be refocused and/or the fiber may be adjusted in the X/Y after each rotation to keep the fiber on screen and in focus. Also the imaging sensor depth of focus and/or the distance of the fiber to the imaging sensor may be adjusted to produce different images through the depth of the fiber, which may also produce different imaged positions of key features for analysis. Still further, while rotation of the fiber is disclosed for the purpose of imaging, instead of fiber rotation, it is equally within the disclosure to rotate imaging optics and sensors around the fiber.

It can therefore be seen that the present invention provides an improved method to determine the correct rotation orientation of a fiber with non-circular cladding geometry so that the on screen position of the fiber core may be adjusted to present the flat side of the fiber cladding as a plane perpendicular to the imaging axis of the sensor of the camera so that core alignment before and/or after of a splice may be adjusted/determined to high accuracy. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method of orienting a non-circular fiber in a position that allows reliable alignment and splicing thereof, comprising:
capturing a plurality of images of a non-circular fiber at a plurality of predetermined rotational angles;
locating a numerical position for predetermined key fiber structures within each of the plurality of images to determine key feature positions for each rotational angle;
processing the positions of the key fiber structures within each image to determine the relative positioning between the predetermined key fiber structures for each angle of rotation;
mathematically determine at which angle of rotation said relative positioning between the predetermined key fiber structures is symmetrical; and
orient said fiber at said symmetrical angle of rotation.

2. The method of claim 1, wherein said step of capturing a plurality of images of a non-circular fiber at a plurality of predetermined rotational angles further comprises, rotating said fiber to each of said predetermined rotational angles.

3. The method of claim 1, wherein said step of capturing a plurality of images of a non-circular fiber at a plurality of predetermined rotational angles further comprises, rotating an image capturing device to each of said predetermined rotational angles.

4. The method of claim 1, wherein a cross-sectional profile of said non-circular fiber is selected from the group consisting of: a polygonal shape, square, hexagonal, octagonal and elliptical.

5. The method of claim 1, wherein said key fiber structures are selected from the group consisting of: edge boundaries, bright zones and core boundaries.

6. The method of claim 1, wherein the relative position between key fiber structures is the relative position between the edge boundary and the core boundary on each side of said fiber.

7. The method of claim 1, wherein the relative position between key fiber structures is the relative position between the edge boundary and the bright zone on each side of said fiber.

8. The method of claim 1, wherein the relative position between key fiber structures is the relative position between the bright zone and the core boundary on each side of said fiber.

9. A method of splicing a non-circular fiber, comprising:
placing said non-circular fiber into a splicing apparatus;
capturing a plurality of images of a non-circular fiber at a plurality of predetermined rotational angles;
locating a numerical position for predetermined key fiber structures within each of the plurality of images to determine key feature positions for each rotational angle ;
processing the positions of the key fiber structures within each image to determine the relative positioning between the predetermined key fiber structures for each angle of rotation;
mathematically determine at which angle of rotation said relative positioning between the predetermined key fiber structures is symmetrical;
orienting said fiber at said symmetrical angle of rotation;
align a core of said non-circular fiber with a core of another fiber to which said non-circular fiber is to be spliced; and
fusion splice the fibers.

10. The method of claim 9, wherein said step of capturing a plurality of images of a non-circular fiber at a plurality of predetermined rotational angles further comprises, using a rotational adjustment of said splicing apparatus to rotate said fiber to each of said predetermined rotational angles.

11. The method of claim 9, wherein said step of capturing a plurality of images of a non-circular fiber at a plurality of predetermined rotational angles further comprises, rotating an image capturing device about said fiber splicing apparatus to each of said predetermined rotational angles.

12. The method of claim 9, wherein a cross-sectional profile of said non-circular fiber is selected from the group consisting of: a polygonal shape, square, hexagonal, octagonal and elliptical.

13. The method of claim 9, wherein said key fiber structures are selected from the group consisting of: edge boundaries, bright zones and core boundaries.

14. The method of claim 9, wherein the relative position between key fiber structures is the relative position between the edge boundary and the core boundary on each side of said fiber.

15. The method of claim 9, wherein the relative position between key fiber structures is the relative position between the edge boundary and the bright zone on each side of said fiber.

16. The method of claim 9, wherein the relative position between key fiber structures is the relative position between the bright zone and the core boundary on each side of said fiber.
